(19) United States
(12) Patent Application Publication
(10) Pub. No.: US 2025/0014310 A1
(43) Pub. Date: Jan. 9, 2025

(54) TIME-SERIES DATA PROCESSING METHOD

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 18/711,647

(22) PCT Filed: Dec. 9, 2021
(86) PCT No.: PCT/JP2021/045389

§ 371 Date: May 20, 2024

(51) Int. Cl. G06V 10/62; G06V 10/77

(52) U.S. Cl. CPC G06V 10/62; G06V 10/7715

(57) ABSTRACT

A time-series data processing apparatus of the present invention includes: an extracting unit that extracts a feature value of each of a plurality of image regions within an image at each time of day when a target is captured; a generating unit that generates time-series data in which the feature value of each of the plurality of image regions and a measured value measured from the target using a measurement device are parameters; and a detecting unit that detects a state of the target based on the time-series data.

### TECHNICAL FIELD

The present invention relates to a time-series data processing method, a time-series data processing apparatus, and a program.

### BACKGROUND ART

In industrial plants for manufacturing energy (electricity, gas, tap water, etc.), chemical products (crude oil, gasoline, plastic, etc.), metal products (steel, semiconductors, etc.), mechanical products (automobiles, computers, etc.), food, pharmaceuticals and so forth, and facilities such as information processing systems, time-series data including measured values from a variety of sensors is analyzed and the occurrence of an anomalous state is detected and output. Moreover, as described in Patent Literature 1, an image obtained by capturing a target facility is acquired and an anomaly in the target facility is detected using the image. For example, in Patent Literature 1, a plurality of feature values are extracted from each of the regions obtained by dividing the image of the target facility and the plurality of feature values are analyzed to detect an anomaly.

### CITATION LIST

### Patent Literature

Patent Literature 1: Japanese Patent Publication No. 3056053

### SUMMARY OF INVENTION

### Technical Problem

However, the method of detecting the state of a monitoring target using an image as described in Patent Literature 1 needs to perform operations such as installation location of an imaging device that captures an image, adjustment of exposure, and preprocessing of data in accordance with the purpose of detection, and a problem that it takes time to introduce thereby arises.

Accordingly, an object of the present invention is to solve the abovementioned problem that it takes time to introduce a system discriminating the state of a target using an image.

### Solution to Problem

A time-series data processing method as an aspect of the present invention includes: extracting a feature value of each of a plurality of image regions within an image at each time of day when a target is captured; generating time-series data in which the feature value of each of the plurality of image regions and a measured value measured from the target using a measurement device are parameters; and detecting a state of the target based on the time-series data.

Further, a time-series data processing apparatus as an aspect of the present invention includes: an extracting unit that extracts a feature value of each of a plurality of image regions within an image at each time of day when a target is captured; a generating unit that generates time-series data in which the feature value of each of the plurality of image regions and a measured value measured from the target using a measurement device are parameters; and a detecting unit that detects a state of the target based on the time-series data.

Further, a computer program as an aspect of the present invention includes instructions for causing an information processing apparatus to execute processes to: extract a feature value of each of a plurality of image regions within an image at each time of day when a target is captured; generate time-series data in which the feature value of each of the plurality of image regions and a measured value measured from the target using a measurement device are parameters; and detect a state of the target based on the time-series data.

### Advantageous Effects of Invention

With the configurations as described above, the present invention enables speedy introduction of a system that discriminates the state of a target using an image.

### BRIEF DESCRIPTION OF DRAWINGS

FIG. 1 is a block diagram showing the configuration of a time-series data processing apparatus in a first example embodiment of the present invention.

FIG. 2 is a view showing the state of processing of time-series data by the time-series data processing apparatus disclosed in FIG. 1.

FIG. 3 is a view showing the state of processing of time-series data by the time-series data processing apparatus disclosed in FIG. 1.

FIG. 4 is a view showing the state of processing of time-series data by the time-series data processing apparatus disclosed in FIG. 1.

FIG. 5 is a view showing the state of processing of time-series data by the time-series data processing apparatus disclosed in FIG. 1.

FIG. 6 is a view showing the state of processing of time-series data by the time-series data processing apparatus disclosed in FIG. 1.

FIG. 7 is a view showing the state of processing of time-series data by the time-series data processing apparatus disclosed in FIG. 1.

FIG. 8 is a view showing the state of processing of time-series data by the time-series data processing apparatus disclosed in FIG. 1.

FIG. 9 is a view showing the state of processing of time-series data by the time-series data processing apparatus disclosed in FIG. 1.

FIG. 10 is a flowchart showing the operation of the time-series data processing apparatus disclosed in FIG. 1.

FIG. 11 is a flowchart showing the operation of the time-series data processing apparatus disclosed in FIG. 1.

FIG. 12 is a block diagram showing the hardware configuration of a time-series data processing apparatus in a second example embodiment of the present invention.

FIG. 13 is a block diagram showing the configuration of the time-series data processing apparatus in the second example embodiment of the present invention.

FIG. 14 is a flowchart showing the operation of the time-series data processing apparatus in the second example embodiment of the present invention.

### DESCRIPTION OF EXAMPLE EMBODIMENTS

### First Example Embodiment

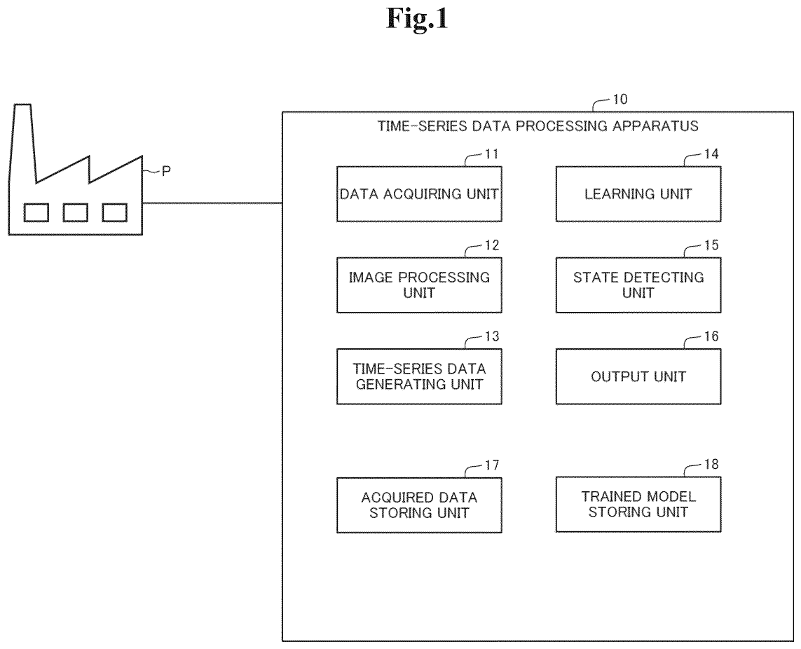

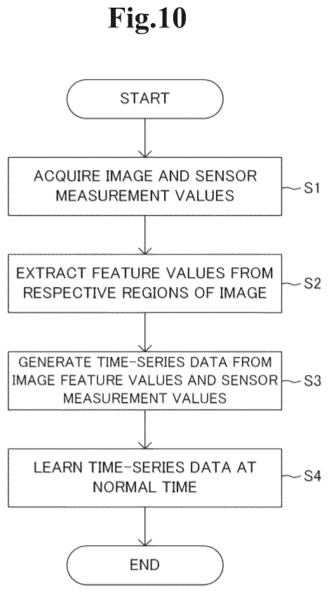

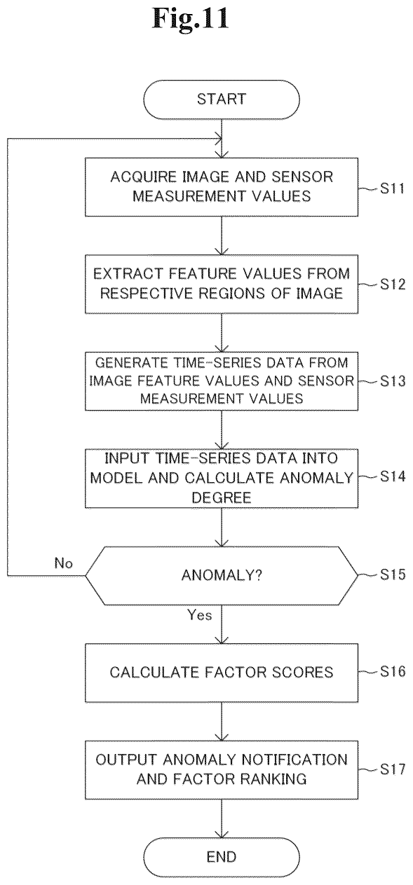

A first example embodiment of the present invention will be described with reference to FIGS. 1 to 11. FIGS. 1 to 9 are views for describing the configuration of a time-series data processing apparatus, and FIGS. 10 and 11 are views for describing the processing operation of the time-series data processing apparatus.

### Configuration

A time-series data processing apparatus 10 in the present invention is connected to a target P for discrimination of the state, such as a plant. Then, the time-series data processing apparatus 10 acquires and analyzes an image of at least part of the target P captured by an imaging device and a measured value measured by a measurement device installed in the target P, and detects the state of the target P based on the analysis result.

Herein, for example, the target P is a plant such as a manufacture factory or a processing facility. In this case, images to be captured are images of equipment and facilities that make up the plant, and measured values to be measured are values such as temperature, pressure, flow rate, power consumption value, feedstock supply, remaining feedstock, vibration frequency, current value, and voltage value related to the plant. Then, it is assumed that the state of the target P detected by the time-series data processing apparatus 10 is the anomalous state of the target P in this example embodiment and the anomalous state is detected from the degree of anomaly calculated based on the time-series data generated from the images and the measured values. Meanwhile, the state of the target P detected by the time-series data processing apparatus 10 is not limited to the anomalous state, and any state such as the normal state or a state where the apparatus is operating in a specific operation mode may be detected or a plurality of states may be detected.

However, the target P for detection of the state in the present invention is not limited to a plant, and may be anything, such as an information processing system or other equipment. For example, in a case where the target P is an information processing system, the state of the information processing system may be detected by acquiring an image of the inside of a data sensor where the information processing system including information processing apparatuses such as a terminal and a server that configure the system is installed and measured values such as the CPU (Central Processing Unit) usage rate, memory usage rate, disk access frequency, the number of input/output packets, input/output packet rate and power consumption value of each of the information processing apparatuses, and analyzing the image and the measured values.

Furthermore, the target P for detection of the state in the present invention may be a structure such as a building or an electric wire, a facility such as a parking lot or a park, an automobile, a train, or an aircraft. In this case as well, the state of the structure or the facility may be detected by acquiring an image of at least part of the structure or the facility and measured values measured from a measurement apparatus installed in the structure or the facility, and analyzing the image and the measured values.

The time-series data processing apparatus 10 is configured with one or a plurality of information processing apparatuses each including an arithmetic logic unit and a memory unit. Then, as shown in FIG. 1, the time-series data processing apparatus 10 includes a data acquiring unit 11, an image processing unit 12, a time-series data generating unit 13, a learning unit 14, a state detecting unit 15, and an output unit 16. The functions of the data acquiring unit 11, the image processing unit 12, the time-series data generating unit 13, the learning unit 14, the state detecting unit 15, and the output unit 16 can be realized by execution of a program for realizing the respective functions stored in the memory unit by the arithmetic logic unit. The time-series data processing unit 10 also includes an acquired data storing unit 17 and a trained model storing unit 18. The acquired data storing unit 17 and the trained model storing unit 18 are configured with the memory unit. Below, the respective components will be described in detail.

The data acquiring unit 11 acquires a moving image including at least part of the target P captured for a predetermined time by an imaging device installed in a place where the target P is located, and stores into the acquired data storing unit 17. In this example embodiment, for example, the data acquiring unit 11 captures a moving image showing equipment and facilities configuring a plant that is the target P as shown in FIG. 1 and stores the moving image in association with the time when captured.

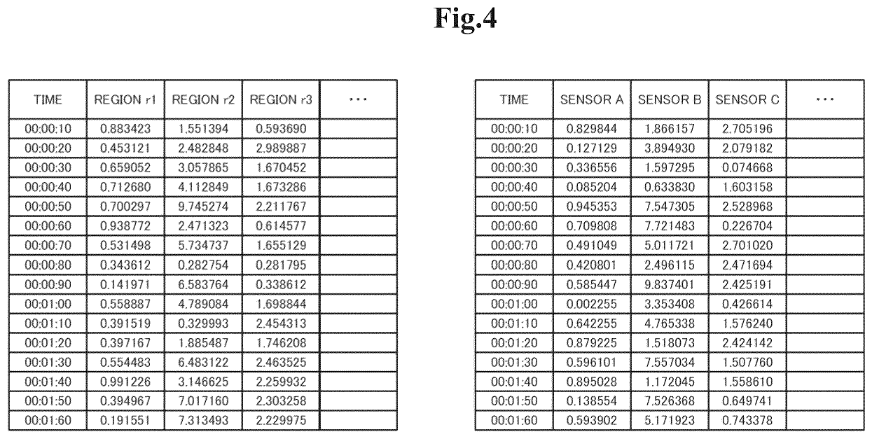

Further, the data acquiring unit 11 acquires measured values measured by various sensors that are measuring devices installed in the target P at predetermined time intervals, and stores into the acquired data storing unit 17. In this example embodiment, for example, multiple types of sensors are installed in the plant that is the target P, and the data acquiring unit 11 acquires a plurality of measured values such as temperature, pressure, flow rate, power consumption value, feedstock supply, and remaining feedstock in the plant measured by the sensors, respectively, and stores the measured values in association with the time of day when measured. As an example, the data acquiring unit 11 acquires measured values from sensors A, B and C, respectively, and stores the respective measured values for each time of day when measured as shown in the right view of FIG. 4. “Time” on the first row in the example of FIG. 4 may be an elapsed time from specific time of day, or may be the actual time of day.

Then, the moving image and the measured values are acquired and stored by the data acquiring unit 11 at all times and, as will be described later, the acquired moving image and measured values are used at the time of generating a trained model used for detecting the anomalous state of the target P and at the time of detecting the anomalous state of the target P, respectively.

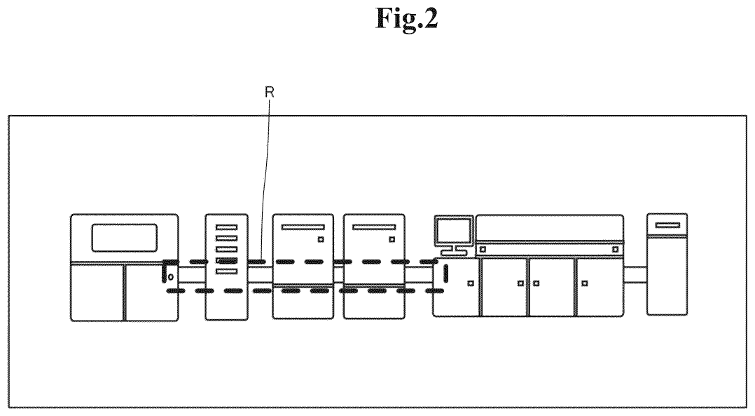

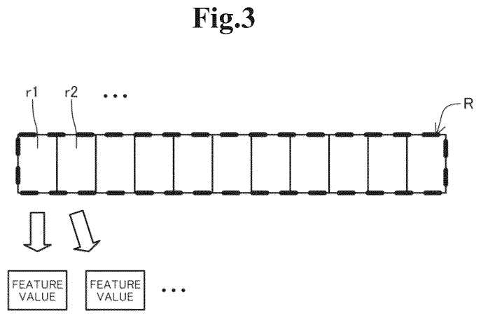

The image processing unit 12 (extracting unit) performs image processing of the moving image of the target P acquired as described above. First, the image processing unit 12 generates a still image for each time of day from the moving image. For example, the image processing unit 12 generates a still image for each time of day such as every 0.1 seconds by converting the moving image into 10 frames of still images per second. Subsequently, as indicated by dotted line in FIG. 2, the image processing unit 12 performs image processing on a monitoring region R set in the generated still image. For example, the monitoring region R is a region set for some reason, such as a region where it is known that a change is likely to occur on an image during an anomalous state in the plant that is the target P. Then, as shown in FIG. 3, the image processing unit 12 further divides the monitoring region R into a plurality of image regions r1, r2 and so forth, and extracts a feature value from image data of each of the image regions r1, r2. At this time, the image processing unit 12 extracts a feature value including one value for one image region. For example, the image processing unit 12 calculates the average value of the brightness values of all pixels in the image region, and extracts the average value of the brightness values as a feature value. However, the image processing unit 12 is not limited to calculating and extracting the average value of the brightness values as the feature value, and may extract any value as the feature value from any image element included in the image region.

In this example embodiment, the image processing unit 12 calculates one feature value from one image region, but may calculate a plurality of feature values from one image region. Moreover, in this example embodiment, a case is illustrated in which the respective image regions r1, r2 set in the monitoring region R are regions obtained by equally dividing the monitoring region R and are formed in the same shape and size as shown in FIG. 3, but the monitoring region R and the image regions r1, r2 may be formed in any shape and size. Moreover, each image region is not necessarily limited to being formed with a region obtained by dividing the monitoring region R. That is to say, the respective image regions are not limited to being arranged adjacent to other image regions, and may be regions that are not adjacent to other image regions and are located discretely within the still image.

Here, in the left view of FIG. 4, an example of the feature value extracted by the image processing unit 12 is shown. As shown in this view, the image processing unit 12 stores the feature values of the respective image regions r1, r2 for each time of day. “Time” on the first row in the example of FIG. 4 may be an elapsed time from specific time of day, or may be the actual time of day.

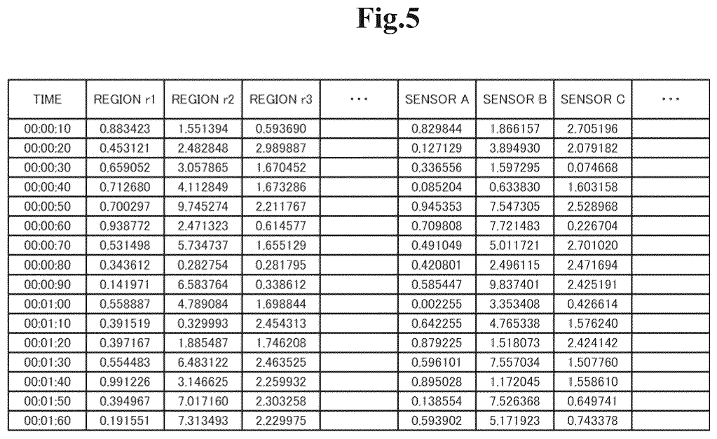

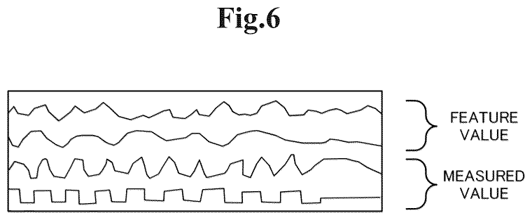

The time-series data generating unit 13 (generating unit) generates time-series data in which the feature values extracted from the respective image regions r1, r2 of the image and the measured values measured from the respective sensors are merged. At this time, as shown in the left view and the right view of FIG. 4, the feature values of the respective image regions r1, r2, r3 and so forth and the measured values acquired from the respective sensors A, B, C and so forth are recorded for each time of day. Therefore, as shown in FIG. 5, the time-series data generating unit 13 associates the feature values and the measured values at the same time of day with each other, and thereby generates time-series data in which the feature values and the measured values are parameters at each time of day. Consequently, as shown in FIG. 6, the time-series data generating unit 13 generates time-series data in which time is set on the horizontal axis and the parameters including the feature values and the measured values are set on the vertical axis. That is to say, the feature values of the respective image regions r1, r2 are treated as the parameters of the time-series data, as with the measured values of the respective sensors A, B, and C. Meanwhile, the time-series data generating unit 13 may use time data of acquisition of the image and the measured values by the data acquiring unit 11 to associate the feature values and the measured values at the same time of day, and thereby generate time-series data. Moreover, FIG. 5 illustrates time-series data including parameters of three feature values and three measured values, and FIG. 6 illustrates time-series data including parameters of two feature values and two measured values, but time-series data may be generated so as to include any number of parameters such as a total of several hundred to several thousand parameters.

In this example embodiment, the time-series data generating unit 13 stores time-series data generated from a moving image and measured values acquired when the target P is operating in a normal state as training data. Moreover, the time-series data generating unit 13 stores time-series data generated from a moving image and measured values acquired when the state of the target P is to be detected as detecting data.

Here, when generating time-series data as training data as described above, the time-series data generating unit 13 may generate time-series data with the feature values of a plurality of different image regions as the parameters of feature values of the same image regions. For example, assume that when the target P is in the normal state, the image shapes of the image region denoted by symbol r1 and the image region denoted by symbol r2 in FIG. 3 are almost the same. In this case, it is considered that the feature values of the image region denoted by symbol r1 and the image region denoted by symbol r2 are the same at all times. Therefore, the feature values of the image region denoted by symbol r1 and the image region denoted by symbol r2 may be treated as the feature value of the image region denoted by symbol r1 and may be used as the parameter of the feature value of the image region denoted by symbol r1. Thus, a large amount of training data can be generated from a small amount of image data.

Meanwhile, the time-series data generating unit 13 is not limited to using time-series data when the target P is operating in the normal state as training data. The time-series data generating unit 13 may use time-series data when the target P is in any state as training data.

The learning unit 14 performs machine learning by inputting time-series data acquired when the target P is determined to be in the normal state as described above and generated as training data, and generates a state discrimination model, which is a trained model that outputs predetermined information in the normal state. For example, the learning unit 14 generates a state discrimination model that outputs information decreasing the value of an anomaly score representing the degree of the anomalous state of the target P when training data is input. Then, the learning unit 14 stores the generated state discrimination model into the trained model storing unit 18. However, the learning unit 14 may generate a state discrimination model that outputs any information when time-series data generated as training data is input. Moreover, in a case where training data are labeled in accordance with a plurality of states of the target P, the learning unit 14 may generate a state discrimination model that performs clustering, which is sorting input time-series data into the states of the respective labels.

Further, the learning unit 14 learns the parameters of the time-series data generated as training data, generates a factor discrimination model as a trained model for each parameter, and stores into the trained model storing unit 18. That is to say, the learning unit 14 performs machine learning by inputting the parameters of the time-series data when the target P is in the normal state for each parameter, and generates a factor discrimination model that outputs predetermined information in the normal state for each parameter. For example, when training data is input for each parameter, the learning unit 14 generates a factor discrimination model that outputs information decreasing the value of a factor score representing the degree of being an impact factor when the target P is in the normal state.

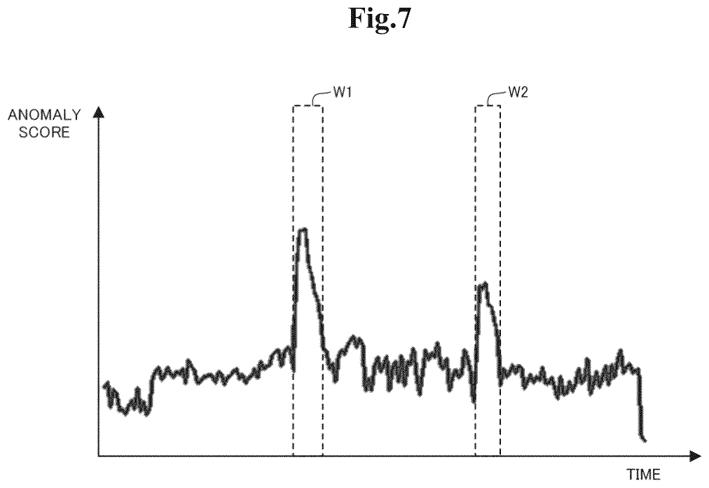

The state detecting unit 15 (detecting unit) inputs detecting data, which is time-series data measured from the target P and stored after generation of the abovementioned trained model, into the state discrimination model stored in the trained model storing unit 18, and detects the state of the target P based on the output by the model. In this example embodiment, the state discrimination model has been trained to output the value of an anomaly score representing the degree to which the target P is in the anomalous state and, when time-series data that is detecting data is sequentially input for each time, outputs an anomaly score for each time as shown in FIG. 7. At this time, it can be said that the anomaly score output from the state discrimination model represents the degree of deviation from the normal state of the time-series data measured from the target P. For this reason, the state detecting unit 15 detects that the target P is in the anomalous state, for example, as shown by periods W1 and W2 in FIG. 7, during periods when anomaly scores higher than those at the other times are output or during a period when an anomaly score higher than a preset threshold is output.

Further, in the case of detecting the anomalous state of the target P, the state detecting unit 15 inputs the respective parameters of the time-series data that is detecting data during the period of detection of the anomalous state, into the factor discrimination models generated for the respective parameters, and detects a parameter to be the factor of the anomaly state of the target P based on the output by the models. In this example embodiment, the factor discrimination model has been trained to output a factor score lower representing the degree of being an impact factor when the target P is in the normal state, the factor score of the parameter to be a factor when the target P is in the anomalous state is output so as to be high compared with the other parameters. For this reason, the state detecting unit 15 detects, as factor parameters, the top few parameters output so as to be high compared with the other parameters or parameters exceeding a preset threshold value.

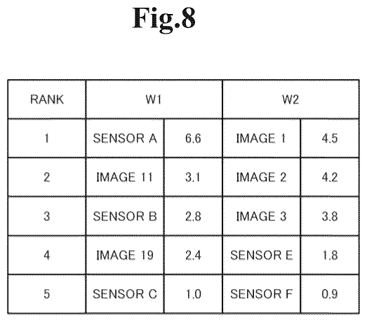

When it is detected that the target P is in the anomalous state as described above, the output unit 16 outputs the fact. For example, the output unit 16 outputs notification information representing a fact that an anomaly has occurred to a registered administrator's e-mail address or a management screen. An example of the notification information is an anomaly score graph showing the periods W1 and W2 when the anomalous state was detected as shown in FIG. 7. In addition, the output unit 16 outputs information on a parameter detected as a factor parameter when the anomalous state of the target P was detected as described above. For example, the output unit 16 outputs information identifying an image region and a sensor that are the sources of the parameter detected as the factor parameter. As an example, as shown in FIG. 8, the output unit 16 outputs, for each of the periods W1 and W2 when the anomalous state was detected, information showing the top five image regions and sensors that are the sources of the parameters detected as factor parameters, for example, image region names and sensor names. At this time, the output unit 16 may output the values of the factor scores together with the image region names and the sensor names as shown in FIG. 8.

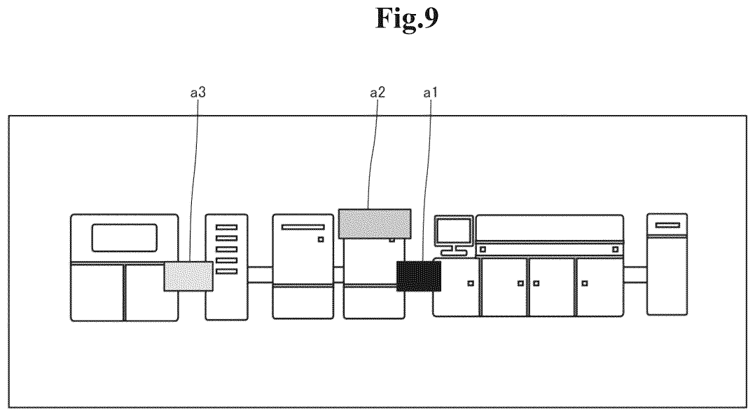

Further, the output unit 16 may output information identifying a place where the anomalous state has occurred together with the image of at least part of the target P. For example, as shown in FIG. 9, the output unit may display, on an image of at least part of the target P, an anomaly indication a1 at a preset location that may be the cause when the anomalous state occurs or may display anomaly indications a2 and a3 at locations of an image region and a sensor detected as factor parameters.

### Operation

Next, the operation of the above time-series data processing apparatus 10 will be described mainly with reference to flowcharts of FIGS. 10 and 11. First, with reference to the flowchart of FIG. 10, the operation in generating a trained model for detecting the anomalous state of the target P will be described.

The time-series data processing apparatus 10 acquires a moving image captured by the imaging device and measured values measured by the respective sensors from the target P operating in the normal state (step S1). Then, the time-series data processing apparatus 10 performs image processing of the moving image. To be specific, the time-series data processing apparatus 10 generates a still image for each time of day from the moving image and, as shown in FIGS. 2 and 3, extracts the feature values of the respective image regions r1 and r2 within the monitoring region R in each still image (step S2). Consequently, the time-series data processing apparatus 10 generates the feature values of the respective image regions r1 and r2 for each time of day.

Subsequently, the time-series data processing apparatus 10 generates time-series data obtained by merging the feature values extracted from the respective image regions r1 and r2 in the image and the measured values measured by the respective sensors (step S3). At this time, as shown in the left and right views of FIG. 4, respectively, the feature values of the respective image regions r1, r2, r3 and so forth and the measured values acquired from the respective sensors A, B, C and so forth are recorded for each time of day. For this reason, as shown in FIG. 5, the time-series data processing apparatus 10 associates the feature values with the measured values at the same time of day and thereby generates time-series data in which the feature values and the measured values are parameters at each time of day. Consequently, time-series data as shown in FIG. 6 is generated, in which time is on the horizontal axis and the feature values and the measurement values are on the vertical axis.

Next, the time-series data processing apparatus 10 performs machine learning using the time-series data generated in the above manner as training data, and generates a state discrimination model, which is a trained model that outputs predetermined information when the target P is in the normal state (step S4). For example, the time-series data processing apparatus 10 generates a state discrimination model that, when training data is input, outputs information such that the value of an anomaly score representing the degree of the anomalous state of the target P is low. Then, the time-series data processing apparatus 10 stores the generated state discrimination model into the trained model storing unit 18. In addition, the time-series data processing apparatus 10 also learns each parameter of the time-series data generated as training data, generates a factor discrimination model as a trained model for each parameter, and stores into the trained model storing unit 18. For example, the time-series data processing apparatus 10 generates a factor discrimination model that, when training data is input for each parameter, outputs information such that the value of a factor score representing the degree of being an impact factor when the target P is in the normal state is low.

Next, with reference to the flowchart of FIG. 11, the operation in detecting the anomalous state of the target P will be described. This operation is operation after generating the trained model in the above manner.

First, the time-series data processing apparatus 10 generates time-series data in which the feature values of an image acquired from the target P and measured values by the sensors are parameters. Specifically, the time-series data processing apparatus 10 acquires a moving image obtained by capturing the target P and measured values by the respective sensors from the target P (step S11). Subsequently, the time-series data processing apparatus 10 extracts the feature values of the respective image regions r1 and r2 within the monitoring region R in the image (step S12). Then, the time-series data processing apparatus 10 generates time-series data in which the feature values extracted from the respective image regions r1 and r2 in the image and the measured values measured by the respective sensors are merged (step S13).

Next, the time-series data processing apparatus 10 inputs detecting data, which is the time-series data generated in the above manner, into the state discrimination model, and detects the state of the target P based on the output by the model. For example, the time-series data processing apparatus 10 inputs the detecting data into the state discrimination model, calculates an anomaly score as shown in FIG. 7 (step S14), and detects that the target P is in the anomalous state during a period when the value of the anomaly score is high (Yes at step S15).

In the case of detecting the anomalous state of the target P (Yes at step S15), the time-series data processing apparatus 10 inputs each of the parameters of the time-series data that is the detecting data during the period when the anomalous state is detected into the factor discrimination model generated for the parameter, and calculates the factor score for each of the parameters (step S16). Then, the time-series data processing apparatus 10 detects, as factor parameters, the top few parameters for which high factor scores compared with those for the other parameters are output or parameters for which factor scores are higher than a preset threshold value.

Next, upon detecting that the target P is in the anomalous state as described above, the time-series data processing apparatus 10 outputs notification information representing the occurrence of the anomalous state (step S17). For example, the time-series data processing apparatus 10 outputs an anomaly score graph showing periods W1 and W2 when the anomalous states are detected as shown in FIG. 7. In addition, as shown in FIG. 8, the time-series data processing apparatus 10 outputs, in a ranking format, information identifying an image region and a sensor that are the sources of the parameters detected as the factor parameters (step S17). Furthermore, as shown in FIG. 9, the time-series data processing apparatus 10 may display anomaly indications a1, a2, and a3 indicating anomaly locations on an image of at least part of the target P.

As described above, in this example embodiment, time-series data is generated in which the feature values of a plurality of image regions within an image obtained by capturing the target P and measured values measured from the target are parameters, and the state of the target is detected based on the time-series data. Since both the feature values of the plurality of image regions and the measured values are the parameters of the time-series data as described above, it is possible to accurately detect the state of the target P without highly accurate acquisition and analysis of the image. As a result, it is possible to simplify an imaging device installation operation and image processing, and it is possible to shorten the time for introducing a system that discriminates the state of a target using an image.

### Second Example Embodiment

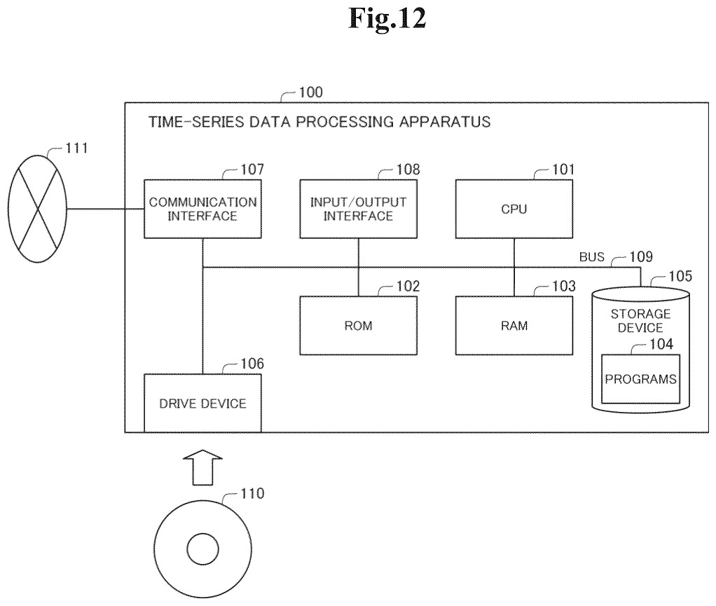

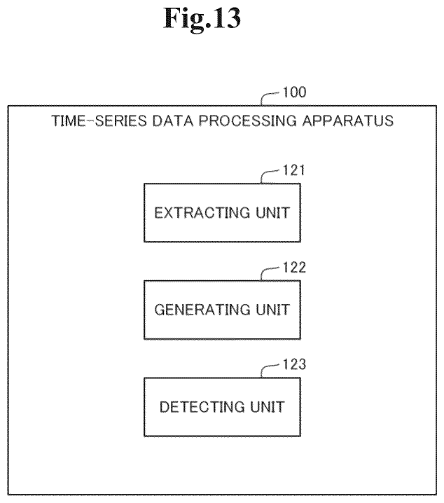

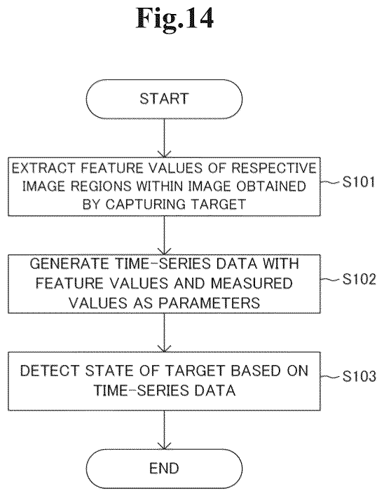

Next, a second example embodiment of the present invention will be described with reference to FIGS. 12 to 14. FIGS. 12 and 13 are block diagrams showing the configuration of a time-series data processing apparatus in the second example embodiment, and FIG. 14 is a flowchart showing the operation of the time-series data processing apparatus. In this example embodiment, the overview of the configurations of the time-series data processing apparatus and the time-series data processing method described in the above example embodiment is shown.

First, with reference to FIG. 12, the hardware configuration of a time-series data processing apparatus 100 in this example embodiment will be described. The time-series data processing apparatus 100 is configured with a general information processing apparatus and, as an example, has the following hardware configuration including;
a CPU (Central Processing Unit) 101 (arithmetic logic unit),
a ROM (Read Only Memory) 102 (memory unit),
a RAM (Random Access Memory) 103 (memory unit),
programs 104 loaded to the RAM 103,
a storage device 105 storing the programs 104,
a drive device 106 reading from and writing into a storage medium 110 outside the information processing apparatus,
a communication interface 107 connecting to a communication network 111 outside the information processing apparatus,
an input/output interface 108 performing input/output of data, and
a bus 109 connecting the respective components.

Then, the time-series data processing apparatus 100 can construct and include an extracting unit 121, a generating unit 122, and a detecting unit 123 shown in FIG. 13 by acquisition and execution of the programs 104 by the CPU 101. The programs 104 are, for example, stored in advance in the storage device 105 and the ROM 102 and loaded to the RAM 103 and executed by the CPU 101 as necessary. Moreover, the programs 104 may be provided to the CPU 101 via the communication network 111, or the programs 104 may be stored in the storage medium 110 in advance and retrieved by the drive device 106 and provided to the CPU 101. However, the extracting unit 121, the generating unit 122, and the detecting unit 123 that are mentioned above may be constructed by a dedicated electronic circuit for realizing these means.

FIG. 12 shows an example of the hardware configuration of the information processing apparatus serving as the time-series data processing apparatus 100, and the hardware configuration of the information processing apparatus is not limited to the abovementioned case. For example, the information processing apparatus may be configured with part of the abovementioned configuration, for example, may be configured without the drive device 106.

Then, the time-series data processing apparatus 100 executes a time-series data processing method shown in the flowchart of FIG. 14 by the functions of the extracting unit 121, the generating unit 122 and the detecting unit 123 constructed by the program as described above.

As shown in FIG. 14, the time-series data processing apparatus 100 executes processes to:
extract respective feature values of a plurality of image regions within an image at each time of day when a target is captured (step S101);
generate time-series data in which the respective feature values of the plurality of image regions and measured values measured from the target using measurement devices are parameters, respectively (step S102); and
detect a state of the target based on the time-series data (step S103).

According to the present invention, with the configurations as described above, both the feature values of a plurality of image regions and the measured values are used as the parameters of the time-series data, so that it is possible to accurately detect the state of the target P without highly accurate acquisition and analysis of the image. As a result, it is possible to simplify an imaging device installation operation and image processing, and it is possible to shorten the time for introduction of a system that discriminates the state of a target using an image.

The abovementioned program can be stored using various types of non-transitory computer-readable mediums and provided to a computer. The non-transitory computer-readable mediums include various types of tangible storage mediums. Examples of the non-transitory computer-readable mediums include a magnetic recording medium (e.g., a flexible disk, a magnetic tape, a hard disk drive), an magneto-optical recording medium (e.g., a magneto-optical disk), a CD-ROM, (Read Only Memory), a CD-R, a CD-R/W, and a semiconductor memory (e.g., a mask ROM, a PROM (Programmable ROM), an EPROM (Erasable PROM), a flash ROM, a RAM (Random Access Memory)). Moreover, the program may be provided to a computer by various types of transitory computer-readable mediums. Examples of the transitory computer-readable mediums include an electric signal, an optical signal, and an electromagnetic wave. The transitory computer-readable mediums can provide the program to a computer via a wired communication path such as an electric wire and an optical fiber or via a wireless communication path.

Although the present invention has been described above with reference to the example embodiments, the present invention is not limited to the above example embodiments. The configurations and details of the present invention can be changed in various manners that can be understood by one skilled in the art within the scope of the present invention. Moreover, at least one or more of the functions of the extracting unit 121, the generating unit 122, and the detecting unit 123 described above may be executed by an information processing apparatus installed in any place on a network and connected, that is, may be executed by so-called cloud computing.

### SUPPLEMENTARY NOTES

The whole or part of the example embodiments disclosed above can be described as the following supplementary notes. Below, the overview of the configurations of a time-series data processing method, a time-series data processing apparatus, and a program will be described. However, the present invention is not limited to the following configurations

### Supplementary Note 1

A time-series data processing method comprising:
extracting a feature value of each of a plurality of image regions within an image at each time of day when a target is captured;
generating time-series data in which the feature value of each of the plurality of image regions and a measured value measured from the target using a measurement device are parameters; and
detecting a state of the target based on the time-series data.

### Supplementary Note 2

The time-series data processing method according to Supplementary Note 1, the method comprising:
extracting one feature value for each of the image regions; and
generating the time-series data in which the feature value for each of the image regions and the measured value are the parameters.

### Supplementary Note 3

The time-series data processing method according to Supplementary Note 1 or 2, the method comprising
generating the time-series data in which the feature value for each of the image regions and the measured value measured at same time of day as time of day when the image from which the feature value is extracted is captured are the parameters at the same time of day.

### Supplementary Note 4

The time-series data processing method according to any of Supplementary Notes 1 to 3, the method comprising
detecting that the target is in a specific state based on the time-series data and also calculating information representing impact degrees of the parameters on the specific state based on the time-series data.

### Supplementary Note 5

The time-series data processing method according to Supplementary Note 4, the method comprising
calculating the information representing the impact degrees of the parameters on the specific state based on values of the parameters when the target is in the specific state and values of the parameters when the target is not in the specific state.

### Supplementary Note 6

The time-series data processing method according to Supplementary Note 4 or 5, the method comprising
identifying the parameter determined to have the high impact degree according to a preset criterion based on the calculated information representing the impact degrees of the parameters on the specific state.

### Supplementary Note 7

The time-series data processing method according to any of Supplementary Notes 1 to 6, the method comprising:
generating a trained model by learning with the time-series data when the target is in a preset state as training data; and
detecting the state of the target based on the time-series data generated by newly acquiring from the target and on the trained model.

### Supplementary Note 8

The time-series data processing method according to Supplementary Note 7, the method comprising
considering the feature value for each of the image regions different from each other within the image as the feature value of the same image region, and generating the time-series data in which the feature value and the measured value are the parameters as the training data.

### Supplementary Note 9

A time-series data processing apparatus comprising:
an extracting unit that extracts a feature value of each of a plurality of image regions within an image at each time of day when a target is captured;
a generating unit that generates time-series data in which the feature value of each of the plurality of image regions and a measured value measured from the target using a measurement device are parameters; and
a detecting unit that detects a state of the target based on the time-series data.

### Supplementary Note 10

The time-series data processing apparatus according to Supplementary Note 9, wherein:
the extracting unit extracts one feature value for each of the image regions; and
the generating unit generates the time-series data in which the feature value for each of the image regions and the measured value are the parameters.

### Supplementary Note 11

The time-series data processing apparatus according to Supplementary Note 9 or 10, wherein
the generating unit generates the time-series data in which the feature value for each of the image regions and the measured value measured at same time of day as time of day when the image from which the feature value is extracted is captured are the parameters at the same time of day.

### Supplementary Note 12

The time-series data processing apparatus according to any of Supplementary Notes 9 to 11, wherein
the detecting unit detects that the target is in a specific state based on the time-series data and also calculating information representing impact degrees of the parameters on the specific state based on the time-series data.

### Supplementary Note 13

The time-series data processing apparatus according to Supplementary Notes 12, wherein
the detecting unit calculates the information representing the impact degrees of the parameters on the specific state based on values of the parameters when the target is in the specific state and values of the parameters when the target is not in the specific state.

### Supplementary Note 14

The time-series data processing apparatus according to Supplementary Note 12 or 13, wherein
the detecting unit identifies the parameter determined to have the high impact degree according to a preset criterion based on the calculated information representing the impact degrees of the parameters on the specific state.

### Supplementary Note 15

The time-series data processing apparatus according to any of Supplementary Notes 9 to 14, comprising
a model generating unit that generates a trained model by learning with the time-series data when the target is in a preset state as training data,
wherein the detecting unit detects the state of the target based on the time-series data generated by newly acquiring from the target and on the trained model.

### Supplementary Note 16

The time-series data processing apparatus according to Supplementary Note 15, wherein
the generating unit considers the feature value for each of the image regions different from each other within the image as the feature value of the same image region, and generates the time-series data in which the feature value and the measured value are the parameters as the training data.

### Supplementary Note 17

A computer-readable storage medium storing a program, the program comprising instructions for causing an information processing apparatus to execute process to:
extract a feature value of each of a plurality of image regions within an image at each time of day when a target is captured;
generate time-series data in which the feature value of each of the plurality of image regions and a measured value measured from the target using a measurement device are parameters; and
detect a state of the target based on the time-series data.

### REFERENCE SIGNS LIST

10 time-series data processing apparatus
11 data acquiring unit
12 image processing unit
13 time-series data generating unit
14 learning unit
15 state detecting unit
16 output unit
17 acquired data storing unit
18 trained model storing unit
100 time-series data processing apparatus
101 CPU
102 ROM
103 RAM
104 programs
105 storage device
106 drive device
107 communication interface
108 input/output interface
109 bus
110 storage medium
111 communication network
121 extracting unit
122 generating unit
123 detecting unit

What is claimed is:

1. A time-series data processing method comprising:
extracting a feature value of each of a plurality of image regions within an image at each time of day when a target is captured;
generating time-series data in which the feature value of each of the plurality of image regions and a measured value measured from the target using a measurement device are parameters; and
detecting a state of the target based on the time-series data.

2. The time-series data processing method according to claim 1, the method comprising:
extracting one feature value for each of the image regions; and
generating the time-series data in which the feature value for each of the image regions and the measured value are the parameters.

3. The time-series data processing method according to claim 1, the method comprising
generating the time-series data in which the feature value for each of the image regions and the measured value measured at same time of day as time of day when the image from which the feature value is extracted is captured are the parameters at the same time of day.

4. The time-series data processing method according to claim 1, the method comprising
detecting that the target is in a specific state based on the time-series data and also calculating information representing impact degrees of the parameters on the specific state based on the time-series data.

5. The time-series data processing method according to claim 4, the method comprising
calculating the information representing the impact degrees of the parameters on the specific state based on values of the parameters when the target is in the specific state and values of the parameters when the target is not in the specific state.

6. The time-series data processing method according to claim 4, the method comprising
identifying the parameter determined to have the high impact degree according to a preset criterion based on the calculated information representing the impact degrees of the parameters on the specific state.

7. The time-series data processing method according to claim 1, the method comprising:
generating a trained model by learning with the time-series data when the target is in a preset state as training data; and
detecting the state of the target based on the time-series data generated by newly acquiring from the target and on the trained model.

8. The time-series data processing method according to claim 7, the method comprising
considering the feature value for each of the image regions different from each other within the image as the feature value of the same image region, and generating the time-series data in which the feature value and the measured value are the parameters as the training data.

9. A time-series data processing apparatus comprising:
at least one memory storing processing instructions; and
at least one processor configured to execute the processing instructions to:
extract a feature value of each of a plurality of image regions within an image at each time of day when a target is captured;
generate time-series data in which the feature value of each of the plurality of image regions and a measured value measured from the target using a measurement device are parameters; and
detect a state of the target based on the time-series data.

10. The time-series data processing apparatus according to claim 9, wherein the at least one processor is configured to execute the processing instructions to:
extract one feature value for each of the image regions; and
generate the time-series data in which the feature value for each of the image regions and the measured value are the parameters.

11. The time-series data processing apparatus according to claim 9, wherein the at least one processor is configured to execute the processing instructions to
generate the time-series data in which the feature value for each of the image regions and the measured value measured at same time of day as time of day when the image from which the feature value is extracted is captured are the parameters at the same time of day.

12. The time-series data processing apparatus according to claim 9, wherein the at least one processor is configured to execute the processing instructions to
detect that the target is in a specific state based on the time-series data and also calculate information representing impact degrees of the parameters on the specific state based on the time-series data.

13. The time-series data processing apparatus according to claim 12, wherein the at least one processor is configured to execute the processing instructions to
calculate the information representing the impact degrees of the parameters on the specific state based on values of the parameters when the target is in the specific state and values of the parameters when the target is not in the specific state.

14. The time-series data processing apparatus according to claim 12, wherein the at least one processor is configured to execute the processing instructions to
identify the parameter determined to have the high impact degree according to a preset criterion based on the calculated information representing the impact degrees of the parameters on the specific state.

15. The time-series data processing apparatus according to claim 9, wherein the at least one processor is configured to execute the processing instructions to:
generate a trained model by learning with the time-series data when the target is in a preset state as training data; and
detect the state of the target based on the time-series data generated by newly acquiring from the target and on the trained model.

16. The time-series data processing apparatus according to claim 15, wherein the at least one processor is configured to execute the processing instructions to
consider the feature value for each of the image regions different from each other within the image as the feature value of the same image region, and generate the time-series data in which the feature value and the measured value are the parameters as the training data.

17. A non-transitory computer-readable storage medium storing a program, the program comprising instructions for causing an information processing apparatus to execute process to:
extract a feature value of each of a plurality of image regions within an image at each time of day when a target is captured;
generate time-series data in which the feature value of each of the plurality of image regions and a measured value measured from the target using a measurement device are parameters; and
detect a state of the target based on the time-series data.
